(19) United States
(12) Patent Application Publication
(10) Pub. No.: US 2007/0030935 A1
(43) Pub. Date: Feb. 8, 2007

(54) Method of synchronization for universal asynchronous receiver-transmitter

(75) Inventor: Yung-Lieh Chien, Taoyuan City (TW)

Correspondence Address: TROXELL LAW OFFICE PLLC;SUITE 1404, 5205 LEESBURG PIKE, FALLS CHURCH, VA, 22041, US

(73) Assignee: Elan Microelectronics Corp.

(21) Appl. No.: 11/363,043

(22) Filed: Feb. 28, 2006

(30) Foreign Application Priority Data
Aug. 3, 2005 (TW) 094126384

(51) Int. Cl. H04L 7/00

(52) U.S. Cl. 375/354

(57) ABSTRACT

A method for a synchronization between two mainframe apparatuses is disclosed, which uses a synchronous module with fast response time, reduced deviation, less electric current consumed and low cost.

### FIELD OF THE INVENTION

The present invention relates to a method of synchronization; more particularly, relates to synchronizing two mainframe apparatuses with fast response time, reduced deviation, less electric current consumed and low cost.

### DESCRIPTION OF THE RELATED ARTS

A general method of a prior art for a transmission between two electronic apparatuses is done through the following steps: (a) a first electronic apparatus sends a synchronous pocket to a second electronic apparatus under a coordination of a first oscillator; (b) after the synchronous pocket is received by a second electronic apparatus, an identification (ID) code is transmitted to the first electronic apparatus by a second oscillator; and, (c) if the ID code is correct, a synchronization between the two apparatus can be set; but, if the ID code is incorrect, a synchronous packet will be transmitted continuously as described in step (a) following with step (b) until obtaining a correct ID code.

The above method of the prior art can synchronize the two electronic apparatuses and the two electronic apparatuses use oscillators of the same frequency for transferring the synchronous packets and the ID code, where the oscillator can be a quartz oscillator or an RC (resistive-capacitive) oscillator. But, when operating the synchronization under a coordination of a quartz oscillator, a deviation up to 3% may occur; and, when operating under an RC oscillator, whose R-part (resist) can be attached and whose C-part (capacity) can be built-in, a deviation up to 10% may even occur during its manufacturing process, which may also be accompanied with a drifting caused by temperature. No matter a quartz oscillator or an RC oscillator is used, the synchronization process is done with more electric current consumed and higher production cost. So, the prior art does not fulfill users' requests on actual use.

### SUMMARY OF THE INVENTION

Therefore, the main purpose of the present invention is to synchronize two mainframe apparatuses using a synchronous module with fast response time, reduced deviation, less electric current consumed and low cost

To achieve the above purpose, the present invention is a method of synchronization for a UART (Universal Asynchronous Receiver-Transmitter), comprising steps of: (a) obtaining a first mainframe apparatus comprising a first transmitting end, a first receiving end and a first oscillator; (b) from the first transmitting end, transmitting at least one synchronous packet comprising a bit with high potential and a plurality of bits with low potential; (c) obtaining a second mainframe apparatus comprising a synchronous module which comprises a second transmitting end, a second receiving end and a second oscillator; (d) receiving the synchronous packet transmitted from the first transmitting end by the second receiving end, and calculating time spent for transmitting the bits with low potential to obtain a transmitting time for one bit; and (e) after finishing the calculation, transmitting an identification code, which is defined by both sides, from the second transmitting end to synchronize the two mainframe apparatus. Accordingly, a novel method of synchronization for a UART is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is a structural view of a preferred embodiment according to the present invention; and

FIG. 2 is a status of use of the preferred embodiment according to the present invention.

### DESCRIPTION OF THE PREFERRED EMBODIMENT

The following description of the preferred embodiment is provided to understand the features and the structures of the present invention.

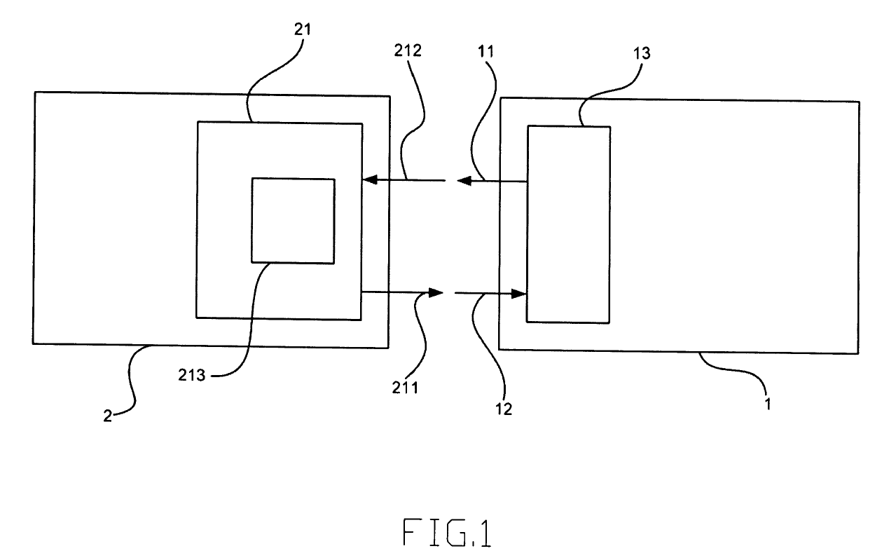

Please refer to FIG. 1, which is a structural view of a preferred embodiment according to the present invention. As shown in the figure, the present invention is a method of synchronization for a UART (Universal Asynchronous Receiver-Transmitter), where the method can synchronize two different apparatuses with fast response time, reduced deviation amount, less electric current consumed and low cost.

The method comprises the following steps:

(a) A first mainframe apparatus 1 is obtained, comprising a first transmitting end 11, a first receiving end 12 and a first oscillator 13, where the first oscillator 13 can be a quartz oscillator or an RC (resistive-capacitive) oscillator.

(b) At least one synchronous packet, which comprises a bit with high potential and a plurality of bits with low potential, is transmitted from the first transmitting end 11 of the first mainframe apparatus 1.

(c) A second mainframe apparatus 2 comprising a synchronous module 21 is obtained, where the synchronous module 21 comprises a second transmitting end 211, a second receiving end 212 and a second oscillator 213; where the second oscillator 213 can be a quartz oscillator or an RC oscillator; and where the synchronous module 21 is a UART.

(d) The synchronous packet transmitted from the first transmitting end 11 of the first mainframe apparatus 1 is received by the second receiving end 212 of the synchronous module 21; and a total time spent for transmitting the bits with low potential are calculated and divided by the number of the bits to obtain transmitting time for one bit.

(e) And, after finishing the calculating and dividing, an identification code defined by both of the first mainframe apparatus 1 and the second mainframe apparatus 2 is transmitted from the second transmitting end 211 of the synchronous module 21 to synchronize the first mainframe apparatus 1 and the second mainframe apparatus 2.

Consequently, a novel method of synchronization for a UART is obtained comprising the above steps.

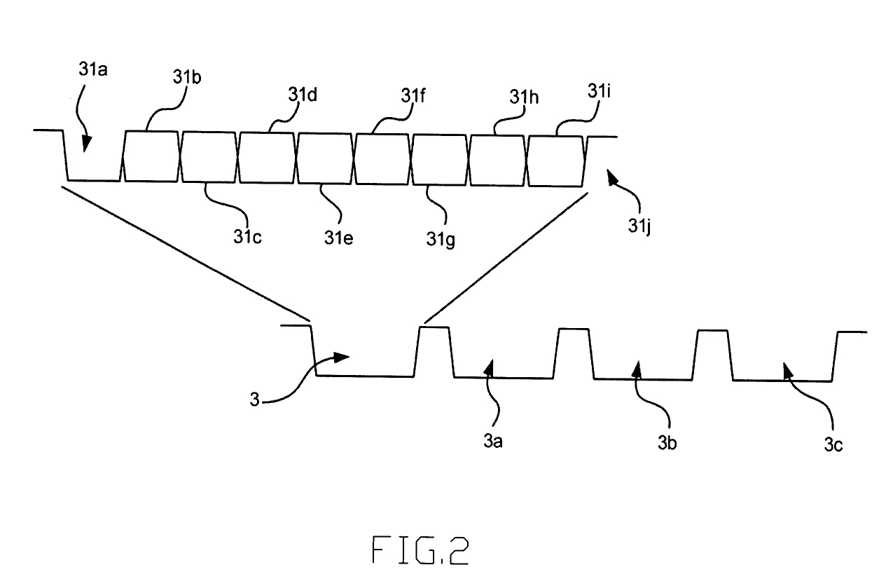

Please further refer to FIG. 2, which is a status of use of the preferred embodiment according to the present invention. As shown in the figure, where transmitting four synchronous bytes 3,3a,3b,3c is taken as an example, one of the synchronous bytes 3 transmitted is examined. In the synchronous byte 3 examined, there are nine bits with low potential 31a,31b,31c,31d,31e,31f,31g,31h,31i and one bit with high potential 31j. Because the number of the bits with low potential 31a,31b,31c,31d,31e,31f,31g,31h,31i is known, the time spent for transmitting the bits with low potential 31a,31b,31c,31d,31e,31f,31g,31h,31i can be calculated after receiving the synchronous byte of the synchronous packet by the second receiving end 212 of the synchronous module 21, where the synchronous packet is transmitted from the first transmitting end 11 of the first mainframe apparatus 1. And the transmitting time for a bit is obtained through dividing the above time by the known number of the bits. After the transmitting time for a bit is figured out by the synchronous module 21 of the second mainframe apparatus 2, an identification (ID) code is transmitted from the second transmitting end 211 of the synchronous module 21 to be received by the first receiving end 12 of the first mainframe apparatus 1. If the ID code the first mainframe apparatus 1 receives is undefined, four synchronous bytes 3,3a,3b,3c will be transmitted again from the first transmitting end 11 of the first mainframe apparatus 1 to have the calculation processed again for transmitting an ID code to be received by the first receiving end 12 of the first mainframe apparatus 1. Such a procedure will be repeated continuously until the synchronous module 21 transmits an ID code defined by both sides. And, when the synchronous module 21 transmits an ID code defined by both sides, the first mainframe apparatus 1 and the second mainframe apparatus 2 can be synchronized.

Take a transmission having a baud rate of 9600 bps (bits per second) as an example. Thus, time for transmitting a bit is 104 us (microsecond). When a frequency deviation for the second mainframe apparatus 2 is ±15%, the deviation for transmitting a bit would be −14 us to +19 us. So, the deviation for transmitting ten bits would be −140 us to +190 us, that is, a deviation of −1.35 bytes to +1.83 bytes. If a synchronous packet to be transmitted is defined as a byte of (00,00,00,00), the byte includes nine bits with low potential. An instance obtained from an actual survey under the frequency deviation of ±15% shows a time of 1260 us±2 us for transmitting nine bits with low potential, where ±2 us is a real-time deviation in the actual survey. Consequently, transmitting time measured for the synchronous packet can be divided by nine to obtain a transmitting time for a bit; and, a deviation of 33 us can be reduced to 0.44 us per bit.

To sum up, the present invention is a method of synchronization for a UART, where a synchronization between two mainframe apparatuses can be done by a synchronous module with fast response time, reduced deviation, less electric current consumed and low cost.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of synchronization for a UART (Universal Asynchronous Receiver-Transmitter), comprising steps of:
(a) obtaining a first mainframe apparatus comprising a first transmitting end, a first receiving end and a first oscillator;
b) from said first transmitting end, transmitting at least one synchronous packet comprising a bit with high potential and a plurality of bits with low potential;
(c) obtaining a second mainframe apparatus comprising a synchronous module which comprises a second transmitting end, a second receiving end and a second oscillator;
(d) receiving said synchronous packet transmitted from said first transmitting end by said second receiving end, and calculating time spent for transmitting said bits with low potential to obtain a transmitting time for one bit; and
(e) after said calculating, transmitting an identification code defined by both of said first mainframe apparatus and said second mainframe apparatus from said second transmitting end to synchronize said first mainframe apparatus and said second mainframe apparatus.

2. The method according to claim 1, wherein said first oscillator is a quartz oscillator.

3. The method according to claim 1, wherein said first oscillator is an RC (resistive-capacitive) oscillator.

4. The method according to claim 1, wherein said synchronous module is a UART.

5. The method according to claim 1, wherein said second oscillator is a quartz oscillator.

6. The method according to claim 1, wherein said second oscillator is an RC oscillator.

7. The method according to claim 1, wherein said transmitting time for one bit in step (d) is obtained by dividing said time spent for transmitting said bits with low potential by number of said bits with low potential transmitted.
